(19) United States
(12) Patent Application Publication
(10) Pub. No.: US 2014/0065587 A1
(43) Pub. Date: Mar. 6, 2014

(54) Personal Communication Device For Managing Individual Fitness Training

(71) Applicant: SimpliFlow GmbH, Vienna (AT)

(72) Inventor: Walter Liebhart, Klagenfurt (AT)

(73) Assignee: SIMPLIFLOW GMBH, Vienna (AT)

(21) Appl. No.: 14/010,645

(22) Filed: Aug. 27, 2013

(30) Foreign Application Priority Data
Aug. 28, 2012 (EP) 12006091.8

(51) Int. Cl. G09B 19/00

(52) U.S. Cl. CPC G09B 19/00
USPC 434/247

(57) ABSTRACT

Managing individual fitness training over a communications network comprising a mobile client device (1) such as a smartphone, a server (2) and a computer program. Upon performing a physical self-testing conducted by the mobile client device (1), the server (2) generates a training plan and provides it to the mobile client device (1). During the training, the mobile client device (1) acquires training data (e.g. via GPS, pedometer, accelerometer, gyroscope, camera), analyses the training, provides feedback to the athlete and supports social networking.

Optionally, the mobile client device (1) is communicatively connected to an on-body sensor (3) via short-range communications.

### FIELD OF INVENTION

The invention relates to a mobile communication device such as a smartphone, a server and a computer program for managing individual fitness training over communications networks. Basically the invention provides for generating training plans, supervising and analysing the training as well as interacting with social networks.

### BACKGROUND OF INVENTION

Concepts are known to determine stress levels during physical exercises and/or advice persons to intensify/reduce workout pace e.g. based on heart rate measurements. Furthermore concepts are known to record physical parameters during workout and to provide respective statistics and charts.

WO 2012/071548 discloses a concept comprising an image capture device to capture images of a user while performing athletic movements.

WO 2012/021507 discloses an athletic performance monitoring and tracking system that provides for coaching in order to improve workouts and overall athletic performance.

Further related prior art can be found in WO 01/97155 and US 2011/281249.

### SUMMARY OF INVENTION

The present invention relates to managing individual fitness training comprising a personal mobile communication (or client) device such as a smartphone, being in communication with a server over a mobile communications network and/or the Internet. An athlete aiming at achieving a certain fitness level registers at the server via the mobile client. Upon registration, the server provides data to the mobile client which then instructs the athlete to perform a physical self-testing (e.g. set of standardised exercises) in order to determine the physical constitution of the athlete.

The thus received self-test parameters are sent to the server where they are thoroughly analysed (e.g. by means of a knowledge base). A result in terms of a score for each test discipline is determined and, based on the score values, a personalised training plan is generated. Finally the training plan (e.g. covering a time frame of several weeks) is communicated to the mobile client which then instructs/leads the user throughout the whole training. The training plan may be modified/adapted based on parameters collected during the individual exercises, or via intermediate self tests.

Test parameters are either provided to the mobile client manually (e.g. manual input of heart rate, time, energy intake) or automatically by the mobile client (e.g. by means of GPS, accelerometer, gyroscope) and/or separate on-body sensors.

Social networking is provided such that e.g. an athlete may search for other persons in the vicinity having a similar training plan (or score levels).

In one aspect of the invention, there is provided a computer-implemented method for managing individual fitness training with a mobile communication device. The method comprises connecting communicatively a mobile client device (1) to a server (2), the server (2) providing to the mobile client device (1) a fitness testing application for a user to perform a physical self-test, the mobile client device (1) providing instructions of the physical self-test to the user to conduct the physical self-test and collecting results of the physical self-test, the mobile client device (1) transmitting the results to the server (2), the server (2) analysing the received results, generating a training plan based on the analysis and communicating the training plan to the mobile client device (1), and the mobile client device (1) providing instructions to the user to conduct training according to the received training plan.

In addition, there is provided a non-transitory computer readable medium having computer program data stored thereon. Upon execution of the data by a suitable computing device, the computer implemented method, including various optional features of the method if implemented, will be performed.

In another aspect of the invention, there is provided a system for managing individual fitness training. The system comprises a server (2), and a mobile client device (1) configured to be communicatively connected to the server. The server is configured to provide to the mobile client device a fitness testing application for a user to perform a physical self-test, the mobile client device is configured to provide instructions of the physical self-test to the user to conduct the physical self-test, to collect results of the physical self-test, and to transmit the results to the server, the server is further configured to analyse the results received from the mobile client device, to generate a training plan based on analysis of the received results and to communicate the training plan to the mobile client device (1), and the mobile client device (1) is further configured to provide instructions to the user to conduct training according to the received training plan.

In another aspect of the invention, there is provided a non-transitory computer readable medium having computer program data stored thereon. Upon execution of the data by a mobile client device, the mobile client device performs the steps of a computer implemented method for managing individual fitness training. The method comprises the steps of connecting communicatively the mobile client device (1) to a server (2), receiving from the server (2) a fitness testing application for a user to perform a physical self-test, providing instructions of the physical self-test to the user to conduct the physical self-test and collecting results of the physical self-test, transmitting the results to the server (2), receiving from the server (2) a training plan generated by the server (2) based on analysis of the received results, and providing instructions to the user to conduct training according to the received training plan.

In yet another as aspect of the invention, there is provided a non-transitory computer readable medium having computer program data stored thereon. Upon execution of the data by a suitable computing device, the suitable computing device performs a computer implemented method as a server (2). The method performed by the server comprises the steps of connecting communicatively the server to a mobile client device (1), providing to the mobile client device (1) a fitness testing application for a user to perform a physical self-test, receiving from the mobile client device (1) results of the physical self-test performed by the user according to instructions of the physical self-test, and analysing the results, generating a training plan based on analysis of the received results and communicating the training plan to the mobile client device (1).

In yet another aspect of the invention, there is provided a computer implemented method for managing individual fitness training with a mobile communication device. The method comprises the steps of connecting communicatively a mobile client device (1) to a server (2), the server (2) providing to the mobile client device (1) a fitness testing application that is arranged to instruct a user to perform a physical self-test, whereby the physical self-test comprises a basic set of exercises, the mobile client device (1) instructing the user to perform the physical self-test and collecting results of the physical self-test, the mobile client device (1) transmitting the results to the server (2), the server (2) determining a score for each exercise of the physical self-test based on the received results, and, based on the scores, generating a training plan, the server (2) communicating the training plan to the mobile client device (1), and the mobile client device (1) instructing the user to perform training according to the received training plan.

In other aspects the invention provides various combinations and subsets of the aspects described above.

### BRIEF DESCRIPTION OF DRAWINGS

FIG. 1 illustrates an embodiment of the present invention.

FIG. 2 illustrates a computer implemented method according to the present invention.

### DETAILED DESCRIPTION

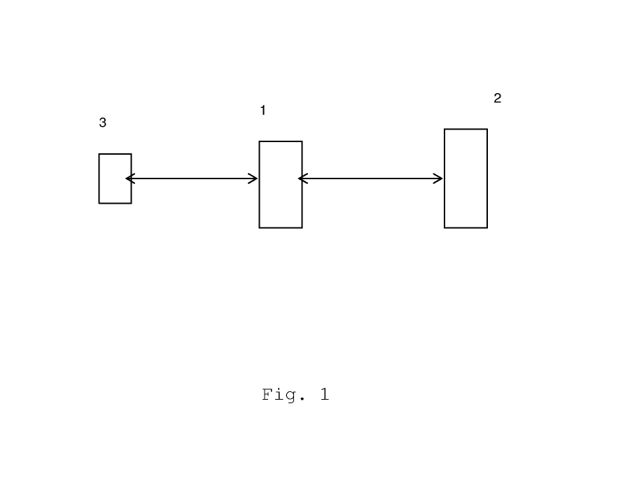

FIG. 1 shows a personal mobile client device 1 such as a smartphone or PDA. The client device is communicating with at least one server 2 over a communications network such as a public (mobile) telecommunications network (e.g. PSTN, GSM) and/or the Internet. The server is connected to (or comprises) a knowledge base for fitness applications. Furthermore the system may also comprise one or more on-body (or wearable) sensors 3 which are arranged to communicate with the mobile client via one-way or two-way short-range communications (e.g. Infrared, Bluetooth).

Physiological parameters (e.g. electrocardiographic data, heart rate) and other parameters such as acceleration, time, distance/pedometer may be determined by the on-body sensor(s) and/or the mobile device depending on the respective capabilities. Furthermore parameters such as weight, gender and age may be provided to the mobile client manually.

Essentially the mobile device acts as a training coach for the athlete and provides for monitoring, teaching, measuring, analysis and social networking.

In this regard, the mobile client device provides relevant training information (e.g. exercise type, starting time, duration, intensity, how to correctly perform exercise) in a multimedia-based form (i.e. text, audio, video, image, animation, interactivity) to the athlete. As an example the speed of playing animations may be based on a required intensity level. Alternatively vibrations, verbal announcements or audio/visual effects on the mobile device may indicate the required intensity.

Furthermore, the mobile client collects any relevant data of the athlete before, while and after exercising. This way the mobile device monitors the exercise and provides haptic or multimedia-based feedback to the athlete. As an example when it is determined (e.g. via GPS or pedometer) that the performance level (e.g. walking/running speed) is too low, respective feedback is provided. Video analysis further allows to control proper execution of the exercises. Thereby a video taken by the mobile client may be sent to the server for analysis. A (basic) analysis may even be provided by the mobile client itself.

The optional on-body sensor 3 provides additional information to the mobile client via short-range communication. It may comprise GPS, accelerometer, pedometer, gyroscope and/or pulse counting assembly to measure a variety of workout parameters. Depending on the workout the device may be fixed on different regions of a body (e.g. wrist, chest, leg, hip). It therefore comprises an adjustable fixing mechanism such as a belt, a hook, a loop fastener or an adhesive layer.

Furthermore when an athlete uses a device from a different manufacturer (e.g. heart rate monitor) the on-body sensor is arranged to collect data provided by that device. Thus the sensor allows to integrate other fitness related devices so that many physiological parameters may be taken into account by the system. Thus in an alternative version, the on-body sensor may solely comprise an interface for gathering data from other devices.

In the event that the sensor is not within communication distance with the mobile client (e.g. mobile client device is switched-off or not carried while running), the on-body sensor comprises a data storage for intermediately storing the collected data and transferring it to the mobile client at a later time when the communication is restored.

An interface (e.g. display, tweet, speaker) for instantaneous audio/optical/haptic/tactile feedback is optionally provided thereby guiding/coaching the user during a workout session (e.g. different vibrations/forces when intensity is too high/low). Therefore the sensor is arranged to receive respective data from the mobile client device and/or generate such data locally (e.g. processing training data for basic analysis and feedback).

It is to be noted that all or part of the functionality mentioned in this context (e.g. data collection, feedback to athlete) can be implemented in the mobile client device and/or the on-body sensor(s). Furthermore functionality provided by other fitness-related devices is integrated thereby allowing a flexible configuration and data acquisition.

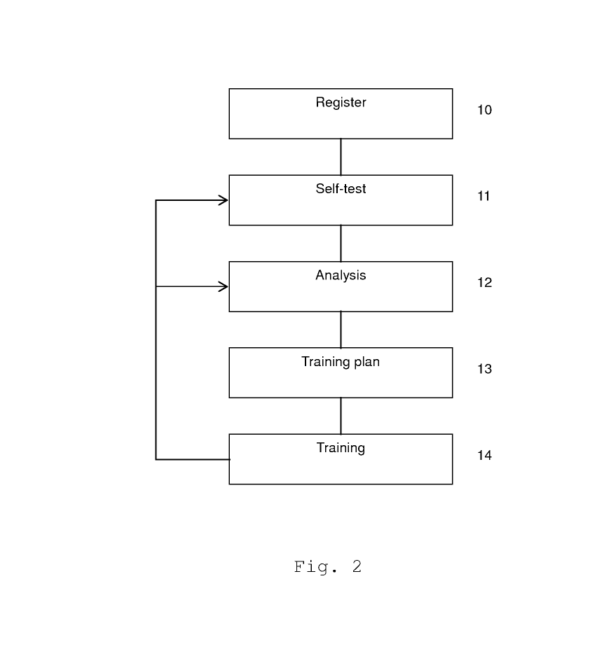

FIG. 2 illustrates the inventive method in a general form.

In step 10, a user registers his mobile client device over the communications network in the server in order to qualify for the service (e.g. sending an electronic message via the mobile client to the server to request a registration form or accessing a respective Internet page). Then the server provides a fitness testing routine (or application) to the mobile client (step 11). This fitness test comprises a basic set of standardised exercises in various disciplines (e.g. jumping power, endurance, speed) and a set of instructions of how to perform each exercise. It is primarily intended to assess the physical constitution of the user at the present time (self-testing). Typically this self-testing routine is loaded into the mobile device and then started locally. Alternatively it may also be started remotely at the server. The self-test is initiated e.g. by the athlete activating a software button on the touch screen (or launching the self-test routine). Performing the self-test is supported by the mobile client in that instructions of the respective exercises (including how to correctly perform them) are provided to the athlete (e.g. video, animation). Furthermore collecting the relevant result(s) is automated/supported as far as possible, depending on the available hardware (e.g. starting/stopping a timer via voice commands).

When the self-test is finished, the mobile client sends or transmits the collected data (e.g. also including parameters such as weight, gender and age) to the server for analysis (step 12). Thereby the server analyzes the results, and may comprise/consult a knowledge base to determine a score (e.g. 1-5) for each of the standard exercises.

Based on these scores, a training plan is generated (step 13). This plan may consist of a huge set of different exercises (up to several hundreds) to be performed over a period of up to several weeks and/or months. In addition the plan might also be sent (or “channeled”) to a medical/fitness specialist/coach for modification(s) and/or approval (e.g. automatically sending an electronic message such as an email). Furthermore personal user preferences (e.g. time of day, season, weather, constraints/limitations due to user location and/or calendar) may be considered.

It is contemplated that the scores and/or training plans are calculated (or arranged) by an expert system in general and by a self-learning expert system in specific.

For each exercise the system holds information about which muscles (or muscle groups) are activated. Eventually this may also be complemented by an intensity level. Thus when an athlete performs a certain exercise, the system knows which muscle is involved at what intensity levels. Information to that regard may be communicated to the athlete at any time e.g. by displaying a human model showing the activated muscles for a particular exercise, a training session or even the whole training plan. Different colours may be applied to reflect the respective and/or accumulated intensity level. In particular when an athlete arranges his training manually (e.g. entering a mode for manually selecting exercises to compose a training plan), this feature is advantageously in order to identify and avoid overloaded/overstrained muscles.

In any case, the training plan is then communicated to the mobile client which supports the user in putting the training plan into action (step 14). In particular, instructions are provided by the mobile client to the user to conduct the training according to the received training plan. A live connection to a personal coach or video analysis may be optionally established in order to guarantee a proper workout.

Results, collected manually and/or automatically by means of the mobile client and/or the sensor(s), are sent to the server in a timely manner. This allows to continuously re-calculate the user's fitness level (e.g. scores). As a further aspect, it is contemplated to feed this data and/or training plan into a social network such that e.g. a user may search for other athletes with a similar fitness level or training plan.

During the training (e.g. after an exercise has been finished), the user may optionally initiate a further self-test (or analysis) in order to receive an updated training plan from the server (see arrows in FIG. 2).

Apart from generally managing training such as described above, the system is further arranged to support an athlete in many ways before, during and after workout sessions.

With regard to supporting an athlete prior to a training session, notifications of an upcoming exercise are generated in advance (e.g. reminder). One possibility to do so, is to integrate the training plan (received from the server) into a calendar application of the mobile client, thereby eventually utilising an already available/installed applications. This also allows to coordinate the training plan with other responsibilities (e.g. private, business). As an example, workout lessons shortly before or after an important business meeting (or during working hours in general) may be avoided. Optionally training sessions may be started manually when the conditions (e.g. time, place, temperature) are appropriate. Depending on where the meeting is to take place (e.g. geographical region) lessons may even be rescheduled for another day (e.g. either one day before or after the meeting) and/or training facilities (e.g. fitness center) may be arranged/booked accordingly.

When an athlete travels to a new location (e.g. business trip) the system helps to find (and eventually book) proper training facilities (e.g. running track, fitness studio).

Other conditions/parameters that may influence the training plan are weather, location, environmental data (e.g. atmospheric ozone) and traffic. These parameters are determined by the mobile client (e.g. via Internet search) and checked against the calendar/training plan. When bad weather conditions(e.g. rain, storm) and/or environmental risks (e.g. heavy ozone concentration) are to be expected/predicted for a given time and location, training sessions might be rescheduled (e.g. earlier in the morning; relocated/moved to indoor location). Alternatively heavy exercises might be replaced by light ones and/or the intensity level may be reduced accordingly.

In a similar way, training might be rescheduled when the training location would be difficult to be reached (e.g. traffic jams, delays with regard to public transportation such as train, bus and underground).

When a session is missed, the system allows to arrange (e.g. finding a track, booking a gym or facility) for a proper substitution.

With regard to social networking the concept provides for finding other athletes with similar fitness levels and/or training plans. By means of e.g. matching calendars and/or training plans of registered users, groups might be formed so that these athletes are encouraged to exercise together. The connection to the social network is provided by the mobile client device and/or the server.

Furthermore the concept supports to form other groups having similar or particular characteristics such as e.g. training plan, fitness level, group membership (gym membership) or friends in order to exercise together (or even to compete with each other).

During a workout session the mobile client collects any data that allows to monitor the exercise and/or to provide feedback to the athlete. Thereby the type of data (e.g. motional/physiological data) and the amount of data depend on the capabilities of the involved hardware (i.e. mobile client device, optional on-body sensor/s and other fitness related devices).

As an example when the mobile client determines by means of video analysis that an exercise is not performed properly, a corresponding animation can be provided to the athlete (e.g. demonstrating the correct exercise). Furthermore the speed of the animation may be adapted to the required intensity level.

A basic analysis may be provided by the mobile client or even the sensor/s while a further analysis is supported by the server via a respective data communication (e.g. live streaming).

As a further feature the provision of real-time data to a community is contemplated (e.g. picture/video, map location, running speed).

Feedback to the athlete is provided by the mobile client and/or the optional sensor/s.

Hardware components—installed in the mobile client or the wearable sensor(s)—are provided to perform various measurements and/or analysis such as:

time measurements: e.g. by means of a real-time clock

velocity/speed/distance: e.g. by means of GPS, pedometer (together with time measurement)

movements/motion analysis: based on optical motion tracking/capturing by means of optical sender and receiver such as e.g. (infrared) LED and (infrared) camera

kinematic analysis: e.g. by means of accelerometer, pedometer, gyroscope for measuring kinematic quantities (e.g. velocity/speed, acceleration, rotation, position, orientation, torque, angular momentum and other forces)

physiological parameters: e.g. heart rate, pulse, burned energy/calories

Of course, in order to obtain valuable results, at least some of the hardware components (e.g. accelerometer, gyroscope, optical sender) have to be attached to respective body parts (e.g. leg, arm).

When a workout session is finished, the mobile client device sends the collected data to the server for analysis, calculating results, providing statistics (e.g. logging and displaying running track), adjusting training plans and sharing/comparing results with others (e.g. social networking).

As an example, all exercises which the athlete has performed are saved in a respective user-profile. Daily, weekly, monthly and yearly training reports are generated and may also show the user which muscle groups and body parts he/she has activated in what intensity and how much time was spent during the training. Such historical and statistical data allow the user to determine his/her personal training progress.

As already noted above, the training plan is generated based on the analysis of the physical constitution (e.g. determined during the self-test or intermediate tests during the training) and other generic parameters such as age, gender and/or weight. In addition other medical/physiological data may also be taken into consideration. In particular injuries (e.g. athletic injuries such as tearing a muscle) and health-related problems (e.g. diseases, chill/cold) are important to be taken into account for the training. Various input options may be presented to the athlete to collect such information.

As an example, a graphical (e.g. two- or three-dimensional) human model is provided to support the athlete gathering such information. The model may display/illustrate the human anatomy including organs (e.g. kidney) and/or body parts (e.g. leg, shoulder) and/or the muscle structure so that the athlete simply selects an organ (or body part or muscle) and briefly describes the relevant medical condition/state. As an example, when a muscle hurts, the athlete selects this muscle (or muscle group) on the model and specifies the pain (e.g. mild, moderate, strong/sever) by means of a pre-defined mask and/or menu options for that muscle. Thus the training may be modified (e.g., by the server or the mobile client) in order to reflect these conditions (e.g. temporarily reducing burden on that specific muscle).

It is in particular advantageous to provide an interactive or animated three-dimensional (3D) human model to support identifying problematic areas.

Possible implementations for animated models are the following:
A 3D animated corpus for injury identification: Within this feature the user/athlete has the opportunity to detect the injury area. As an example he/she is clicking on his/her shoulder, mark the shoulder and save it as part of the body which causes pain. Then the user has the opportunity to select pain levels (e.g. scaling from 1 to 10, whereby 1 equals green and 10 equals dark red). The collected information is shown to the channels the athlete has defined (e.g. trainers, coaches, doctors, therapists). The involved parties have the opportunity to send the athlete/user exercises related to the injury. Injury related exercises are shown to the coaching staff based on the selection of the athlete/user on the 3D corpus. As soon as the athlete/user feels better, he can change the status of his shoulder (level of pain). Again this information is shared with his channels. All injuries are saved in the profile of the athlete so he/she can fall back to an injury history. The level of pain is deposited with textual information (e.g. slight pain, strong movement limitation, no active movement possible).
A 3D animated corpus for self made training planning: All available exercises in the knowledge management system are tagged to exercise specific muscle groups. When the user has access to the exercise portfolio (depending on the version he/she is using) then he/she can stick to a training plan via a professional training plan feature. Thereby the user selects exercises in order to compose a training. When the user is selecting for example a lot of exercises which activate a specific body part and/or muscle group then these parts are coloured (e.g. from white to red). If the body part or muscle group is shown red in the 3D animated corpus then the user knows that there is an overstraining of this specific body part.
   All exercises which the athlete/user has chosen are saved in his profile. Periodic training reports are generated, showing the muscle groups and body parts he/she has activated in what intensity and how much time was spent during the training.
   Possible colours are:
   White: No activation in the period
   Grey: Very low activation
   Green: adequate activation
   Orange: slight overstrain
   Red: Strong overstrain
A 3D animated corpus for sports specific training analysis and training control:
   Based on the described model of a self made training all exercises which are chosen by the system and via the professional feature are tagged and saved, grouped by muscle groups and body parts. Furthermore the system automatically shows the athlete/user/trainer the sports specific relevant exercises. This means when a sports for example causes an increased shoulder, arm and lower back stress/load, then this is shown via the 3D corpus. The selected exercises of the system are automatically geared after the sports specific demand to avoid injuries. The professional feature also shows the trainer whether there is an overstrain of sensitive and/or specific body parts or whether there is a gap (or inconsistency) in the training structure.

Various embodiments of the invention have now been described in detail. Those skilled in the art will appreciate that numerous modifications, adaptations and variations may be made to the embodiments without departing from the scope of the invention, which is defined by the appended claims. The scope of the claims should be given the broadest interpretation consistent with the description as a whole and not to be limited to these embodiments set forth in the examples or detailed description thereof.

What is claimed is:

1. A computer-implemented method for managing individual fitness training with a mobile communication device, the method comprising:
connecting communicatively a mobile client device (1) to a server (2),
the server (2) providing to the mobile client device (1) a fitness testing application for a user to perform a physical self-test,
the mobile client device (1) providing instructions of the physical self-test to the user to conduct the physical self-test and collecting results of the physical self-test,
the mobile client device (1) transmitting the results to the server (2),
the server (2) analysing the received results, generating a training plan based on the analysis and communicating the training plan to the mobile client device (1), and
the mobile client device (1) providing instructions to the user to conduct training according to the received training plan.

2. The method according to claim 1 wherein the mobile client device (1) is communicatively connected to at least one on-body sensor (3) via short-range communications and the method further comprises the steps of the at least one on-body sensor collecting measurement data and transmitting the measurement data to the mobile client device.

3. The method according to claim 2 wherein at least one of the mobile client device (1) and the at least one on-body sensor (3) comprises at least one of a real-time clock, a Global Positioning System GPS, a pedometer, an accelerometer, a gyroscope and a camera in order to measure kinematic quantities such as velocity, acceleration, rotation, position, orientation, torque and angular momentum and/or providing motion analysis.

4. The method according to claims 2, further comprising the step of at least one of the mobile client device (1) and the at least one on-body sensor (3) providing multimedia and/or tactile feedback to the user.

5. The method according to claim 1 further comprising the step(s) of integrating the training plan into a calendar application of the mobile client device and/or providing the training plan to a social network.

6. The method according to claim 1, further comprising the steps of the mobile client device (1) collecting data on weather, environment and/or traffic and modifying the training plan in accordance to this data.

7. The method according to claim 1 further comprising the steps of:
the mobile client device (1) displaying an interactive graphical model of human anatomy and muscle structure for selecting organs, body parts or muscles,
the mobile client device receiving input from the user describing relevant medical state of selected organs, body parts or muscles, and
modifying the training plan based on the medical state.

8. The method according to claim 2 further comprising the steps of the at least one on-body sensor (3) storing data intermediately to a data storage when communication with the mobile client device (1) is interrupted and transferring the stored data to the mobile client device when the communication is restored.

9. A system for managing individual fitness training, comprising:
a server (2), and
a mobile client device (1) configured to be communicatively connected to the server,
wherein the server is configured to provide to the mobile client device a fitness testing application for a user to perform a physical self-test,
the mobile client device is configured to provide instructions of the physical self-test to the user to conduct the physical self-test, to collect results of the physical self-test, and to transmit the results to the server,
the server is further configured to analyse the results received from the mobile client device, to generate a training plan based on analysis of the received results and to communicate the training plan to the mobile client device (1), and
the mobile client device (1) is further configured to provide instructions to the user to conduct training according to the received training plan.

10. The system according to claim 9, wherein the mobile client device (1) is communicatively connected to at least one on-body sensor (3) via short-range communications.

11. The system according to claim 10, wherein at least one of the mobile client device (1) and the at least one on-body sensor (3) comprises at least one of a real-time clock, a Global Positioning System GPS, a pedometer, an accelerometer, a gyroscope and a camera in order to measure kinematic quantities such as velocity, acceleration, rotation, position, orientation, torque and angular momentum and/or providing motion analysis.

12. The system according to claim 10, wherein at least one of the mobile client device (1) and the at least one on-body sensor (3) is configured to provide multimedia and/or tactile feedback to the user.

13. The system according to claim 9, wherein the mobile client device (1) integrates the training plan into a calendar application of the mobile client device.

14. The system according to claim 9, wherein at least one of the mobile client device (1) and the server provides the training plan to a social network.

15. The system according to claim 9, wherein at least one of the mobile client device (1) and the server collects data on weather, environment and/or traffic and modifies the training plan in accordance to this data.

16. The system according to claim 9, wherein the mobile client device (1) is further configured to display an interactive graphical model of human anatomy and muscle structure for selecting organs, body parts or muscles, and to receive input from the user describing relevant medical state of selected organs, and at least one of the server and the mobile client device is further configured to modify the training plan based on the medical state.

17. The system according to claim 10, wherein the at least one on-body sensor (3) comprises a data storage for intermediately storing data.

18. A non-transitory computer readable medium having computer program data stored thereon, upon execution of the data by a mobile client device, causing the mobile client device to perform a computer implemented method for managing individual fitness training, the method comprising the steps:
connecting communicatively the mobile client device (1) to a server (2),
the mobile client device receiving from the server (2) a fitness testing application for a user to perform a physical self-test,
the mobile client device (1) providing instructions of the physical self-test to the user to conduct the physical self-test and collecting results of the physical self-test,
the mobile client device (1) transmitting the results to the server (2),
the mobile client device receiving from the server (2) a training plan generated by the server (2) based on analysis of the received results, and
the mobile client device (1) providing instructions to the user to conduct training according to the received training plan.

19. A non-transitory computer readable medium having computer program data stored thereon, upon execution of the data by a suitable computing device, causing the suitable computing device to perform a computer implemented method for managing individual fitness training as a server (2), the method comprising the steps:
connecting communicatively the server to a mobile client device (1),
the server (2) providing to the mobile client device (1) a fitness testing application for a user to perform a physical self-test,
receiving from the mobile client device (1) results of the physical self-test performed by the user according to instructions of the physical self-test, and
the server (2) analysing the results, generating a training plan based on analysis of the received results and communicating the training plan to the mobile client device (1).

20. A computer implemented method for managing individual fitness training with a mobile communication device, comprising:
connecting communicatively a mobile client device (1) to a server (2),
the server (2) providing to the mobile client device (1) a fitness testing application that is arranged to instruct a user to perform a physical self-test, whereby the physical self-test comprises a basic set of exercises,
the mobile client device (1) instructing the user to perform the physical self-test and collecting results of the physical self-test,
the mobile client device (1) transmitting the results to the server (2),
the server (2) determining a score for each exercise of the physical self-test based on the received results, and, based on the scores, generating a training plan,
the server (2) communicating the training plan to the mobile client device (1), and
the mobile client device (1) instructing the user to perform training according to the received training plan.
